(19) United States
(12) Patent Application Publication
(10) Pub. No.: US 2015/0098680 A1
(43) Pub. Date: Apr. 9, 2015

(54) OPTICALLY CONNECTING A CHIP PACKAGE TO AN OPTICAL CONNECTOR

(71) Applicants: Kevin B. Leigh, Houston, TX (US); George D. Megason, Spring, TX (US); Paul Kessler Rosenberg, Sunnyvale, CA (US)

(72) Inventors: Kevin B. Leigh, Houston, TX (US); George D. Megason, Spring, TX (US); Paul Kessler Rosenberg, Sunnyvale, CA (US)

(21) Appl. No.: 14/395,996

(22) PCT Filed: Jul. 27, 2012
(86) PCT No.: PCT/US12/48500

§ 371 Date: Nov. 7, 2014

(51) Int. Cl. G02B 6/42

(52) U.S. Cl. CPC G02B 6/423; G02B 6/4284; G02B 6/4278; G02B 6/428; G02B 6/4206
USPC 385/88

(57) ABSTRACT

An optical communication module has an attachment feature for attachment to a chip package having an electrical-optical converter, the optical communication module to pass light communicated with an electrical-optical converter of the chip package. The optical communication module has an alignment feature to achieve a level of alignment with a system-side optical connector.

### BACKGROUND

Optical communications are increasingly used in systems to achieve data communications at a higher rate, as compared to electrical communications. Optical connections can be provided between various types of devices. Traditionally, fiber optic pigtails are often used to optically interconnect devices. A fiber optic pigtail includes a fiber optic cable that is connected at one end to a first device, and has a connector provided at the other end to connect to a second device.

### BRIEF DESCRIPTION OF THE DRAWINGS

Some embodiments are described with respect to the following figures:

FIGS. 1 and 1A are exploded side views of example optical blind-mate connection arrangements for optically connecting a chip package to a system-side connector, in accordance with some implementations;

FIG. 2 is a side view of the arrangement of FIG. 1, with the chip package optically blind-mated to the system-side connector;

FIG. 3 is a side view of another example optical blind-mate connection arrangement for optically connecting a chip package to a system-side connector, in accordance with further implementations;

FIGS. 3A-3B are side views of further example optical blind-mate connection arrangements for optically connecting a chip package to a system-side connector, in accordance with other implementations;

FIG. 4 is a perspective side view of a section of an example optical blind-mate connection arrangement for optically connecting a mezzanine circuit board to a main circuit board, in accordance with alternative implementations;

FIGS. 5A-5B are perspective side views of another example arrangement that includes an optical blind-mate connection mechanism, and an electrical connection mechanism;

FIG. 6 is a side view of a further example optical blind-mate connection arrangement for optically connecting a mezzanine circuit board to a main circuit board, in accordance with other implementations; and

FIG. 7 is a flow diagram of a processing of assembling a chip package in a larger assembly, in accordance with some implementations.

### DETAILED DESCRIPTION

To support optical communications in a system of devices, electrical-optical converters (which can also be referred to as E/O converters or E/O engines) are provided. An E/O converter converts between electrical signals and optical signals. For example, an E/O converter can include one or both of an optical transmitter and an optical receiver. An example of an optical transmitter includes a laser diode, such as a vertical-cavity surface-emitting laser (VCSEL). An example of an optical receiver includes a photo diode.

The optical transmitter and/or optical receiver can be connected to electrical circuitry. On the transmit side, the electrical circuitry can include a signal driver that produces electrical signals that are output to the optical transmitter. The optical transmitter converts the electrical signals to corresponding optical signals for transmission over an optical medium. On the receive side, the optical receiver receives an optical signal over an optical medium, and converts the optical signal into an electrical signal for processing by an electrical receive circuit.

In some cases, an E/O converter can be a stand-alone discrete device that can be plugged into a larger assembly.

As optical communications technology has advanced, E/O converters can be integrated within integrated circuit devices, such as application-specific integrated circuit (ASIC) devices, programmable gate arrays (PGAs), microcontrollers, microprocessors, multi-chip modules, and so forth.

In other examples, E/O converters can be mounted on a circuit board, such as an adapter card, a mezzanine circuit board, a hot-plug card, and so forth.

In the ensuing discussion, a “chip package” that has an E/O converter can refer to an integrated circuit device that has an E/O converter, a circuit board that has an E/O converter, or a discrete E/O converter device.

Traditionally, fiber optic pigtails can be used to interconnect different devices, including those with E/O converters. However, use of fiber optic pigtails within a system may lead to increased manufacture or assembly complexity, particularly in a system that has a relatively large number of the fiber optic pigtails. Also, to allow an installer to access or manipulate the fiber optic pigtails, additional space has to be provided. Moreover, additional fiber management mechanisms may have to be provided that in turn can lead to higher system implementation cost. The presence of a relatively large number of fiber optic pigtails can also lead to airflow blockage, which can make system cooling more challenging. Additionally, the presence of a relatively large number of fiber optic pigtails in a system can result in more difficulty and additional assembly time in installing additional devices into the system, such as for replacement, repair, or maintenance purposes. Also, human error may be more likely when there are a relatively large number of fiber optic pigtails to interconnect.

In accordance with some implementations, a blind-mate optical connection arrangement is provided to allow for more efficient and robust optical interconnections among devices in a system. A “blind-mate optical connection” refers to connection in which one set of optical device(s) is precisely aligned with respect to another set of optical device(s), by the simple action of inserting an assembly containing the blind mateable optical device(s) into a second assembly. Precision alignment (in the range of 1 um to 50 um, for example) between the optical devices is achieved automatically through the use of mating alignment structures, so that human vision in not involved for aligning the optical devices to make the connection.

More specifically, a blind-mate optical connection arrangement according to some implementations allows a chip package having E/O converters to be efficiently and conveniently connected to a system-side optical connector. As noted above, the chip package can include an integrated circuit device, a circuit board, or a discrete E/O converter device.

The system-side optical connector is associated with a target assembly, such as a main circuit board, an electronic device, or any other assembly to which the chip package is to be optically connected.

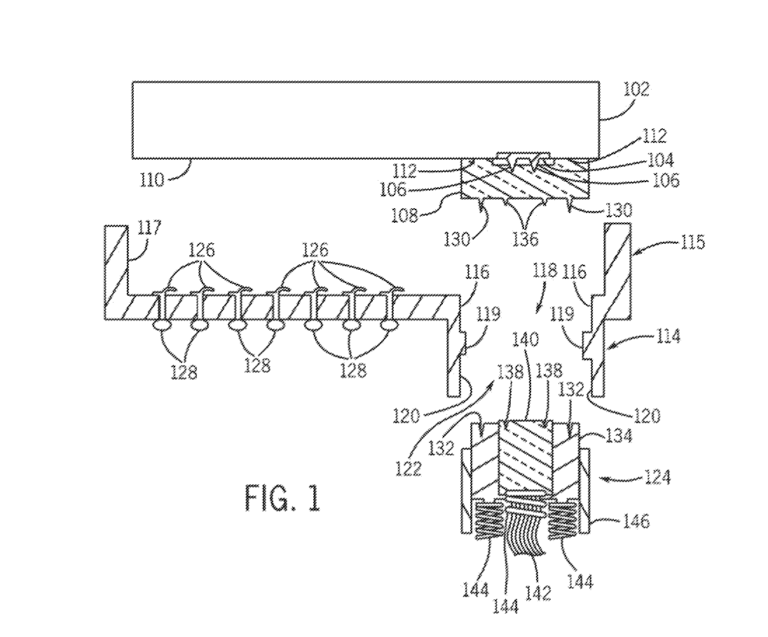

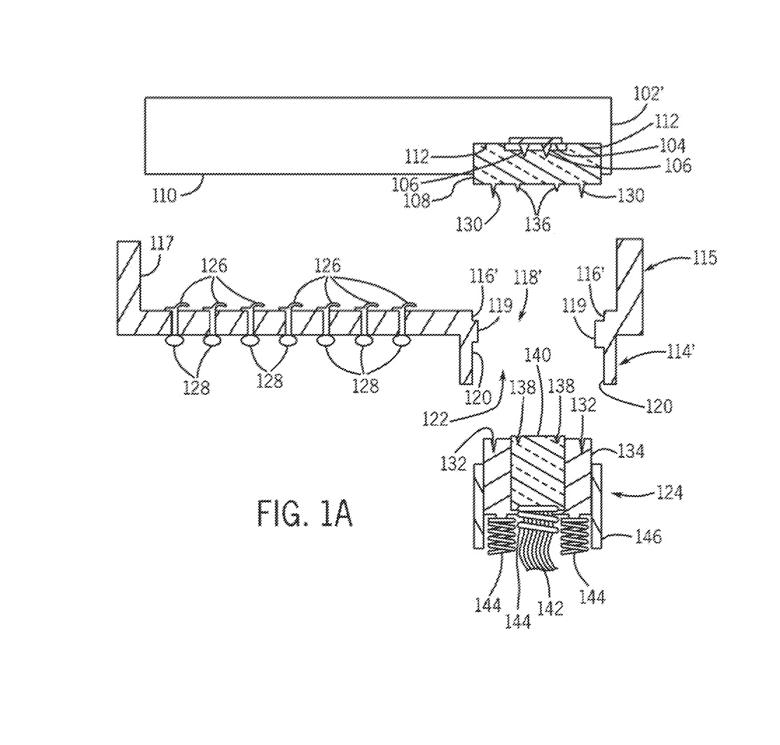

FIG. 1 depicts an example arrangement that includes a chip package 102, where the chip package 102 has an integrated E/O converter 104. Although reference is made to a chip package having an E/O converter in the singular sense, it is noted that this is also intended to cover a chip package having multiple E/O converters.

In some examples, the E/O converter 104 can include optical transmitters 106, such as an array (one-dimensional or two-dimensional array) of VCSELs. Note, that the E/O converter 104 can additionally or alternatively include optical receivers, such as photodiodes. When used in the transmission mode, an optical transmitter 106 can emit light (e.g. laser light) through a lens block 108. The lens block 108 can include one or multiple lenses through which the laser light emitted by the optical transmitters 106 are passed. When used in the receive mode, the lens block 108 can also include one or multiple lenses through which laser light can be passed for receipt by optical receivers that are part of the E/O converter 104.

In examples according to FIG. 1, the E/O converter 104 is located at a lower side 110 of the chip package 102. In other examples, the E/O converter 104 can be located at any advantageous position on the chip package 102.

The lens block 108 has attachment features 112 to allow the lens block 108 to be attached to the lower side 110 of the chip package 102. The attachment features 112 in the FIG. 1 example include generally flat surface that can be bonded or otherwise affixed to the lower side 110 of the chip package 102. Alternatively, the attachment features 112 can include other types of attachment features.

In accordance with some implementations, the blind-mate optical connection arrangement provided in FIG. 1 can include multiple levels of alignment. A first level of alignment can include coarse mechanical alignment provided by a chip-side connector 114 (the chip-side connector 114 can be considered an “optical connector” since it is part of the blind-mate optical connection arrangement shown in FIG. 1). For example, the coarse mechanical alignment can be provided by surfaces 116 within a receptacle 118 that receives the lens block 108. In some examples, the surfaces 116 can be chamfered (or slanted) surfaces to provide the coarse mechanical alignment between the lens block 108 and the chip-side connector 114.

The other side of the chip-side connector 114 also has receiving surfaces 120 defining a receptacle 122 for receiving a housing 146 of the system-side optical connector 124. The side surfaces 120 of the receptacle 122 can also include chamfered (slanted) surfaces to provide coarse mechanical alignment between the chip-side connector 114 and the system-side connector 124

Effectively, the alignment features provided by the chip-side connector 114 allows for coarse alignment between the lens block 108 and the system-side optical connector 124.

In the FIG. 1 example, the chip-side connector 114 is part of a socket 115 that is able to receive the chip package 102, or at least a portion of the chip package 102. As depicted, the socket 115 has a receptacle 117 that is able to receive the chip package 102. Electrical contacts 126 on an upper surface of the socket 115 electrically connect to corresponding electrodes (not shown) on the chip package 102. The electrical contacts 126 are in turn connected by respective vias to electrical contacts 128 on a lower surface of the socket 115. As discussed further below, the electrical contacts 128 of the socket 115 can be used to electrically connect to respective electrical structures on a circuit board (not shown) underneath the socket 115.

A second level of alignment of the blind-mate optical connection arrangement of FIG. 1 can include alignment features 130 that depend or protrude from a lower side of the lens block 108. The alignment features 130 are configured to engage alignment features 132 that are part of a ferrule carrier 134 that is part of the system-side connector 124. In examples according to FIG. 1, the second-level alignment features 130 of the lens block 108 are protrusions that are to be received by holes 132 in the ferrule carrier 134. In different examples, the alignment features 132 of the ferrule carrier 134 can be protrusions, while the alignment features 130 of the lens block 108 can be holes. In other examples, instead of using protrusions and holes, other types of alignment features can be used.

A third level of alignment of the blind-mate optical connection arrangement includes alignment features 136 that extend from a lower surface of the lens block 108. These alignment features 136 (e.g. protrusions) are designed to engage corresponding alignment features 138 (e.g. holes) of a ferrule body 140, which contains ferrules. In different examples, the alignment features 136 can be holes, while the alignment features 138 can be protrusions. In other examples, other types of alignment features can be used.

A “ferrule” refers to an optical interface that holds and precisely positions an optical communications medium, such as optical fiber(s) or optical waveguide(s), such that a ferrule can be aligned with another ferrule to enable optical communication between the optical communications medium within the two ferrules.

The second and third levels of alignment provide finer alignment than the coarse alignment provided by the surfaces 116 and 120 of the chip-side connector 114. Moreover, the third level of alignment is a finer level of alignment than the second level of alignment.

In examples according to FIG. 1, optical fibers 142 extend from a lower side of the ferrule body 140. The optical fibers 142 can couple the optical connector 124 to another device.

As further shown in FIG. 1, springs 144 can be provided at the lower ends of the ferrule carrier 134 and ferrule body 140 to bias the assembly of the ferrule carrier 134 and ferrule body 140 towards the chip-side connector 114. Such biasing facilitates the mating between the lens block 108 and the ferrule body 140 inside the chip-side connector 114.

FIG. 1 also shows a stop feature 119 of the chip-side connector 114 that is designed to limit the movement, in the direction toward the chip side connector, of the lens block 108 and the system-side connector 124 when the respective components are received into the respective receptacles 118 and 122 of the chip-side connector 114.

The lens block 108 may support single-mode or multi-mode optical signals. The optical lenses in the ferrule body 140 may support single-mode or multi-mode optical signals, independently of the lens block supporting single-mode or multi-mode optical signals. In other words, the lens block 108 with lenses to support single-mode optical signal may be coupled with the ferrule body with lenses to support multi-mode optical signals. The optical fibers 142 may be single-mode fiber (SMF) type or a multi-mode fiber (MMF) type. Each SMF-type or MMF-type optical fiber may have a single core or multiple cores, where an optical signal may be transmitted in each core by using a single wavelength or multiple wavelengths.

The lenses used in the lens block 108 and the lenses used in the ferrule body 140 can be either of an imaging or collimating type. The lens type of the lenses used in the lens block 108 and the ferrule body 140 should be matched. The lenses may also be of a bulk lens type or silicon grated lens type. For the bulk lens type, the individual lenses have a particular physical shape profile, e.g. a series of dome-shape lenses. For the silicon grated lens type, the individual lens patterns are etched silicon and they have a substantially flat profile. Either the bulk lens type or the silicon grated lens type may be covered with a protected layer that enhance the optical signal transmission and/or prevent contamination (e.g. dust) from adhering to the lenses.

In the FIG. 1 example, the lens block 108 protrudes from the bottom surface of the chip package 102. In another example (shown in FIG. 1A), the lens block 108 may be provided at least partially in a recess within a chip package 102′, where the attachment features 112 will be within the chip package 102. The lower side of the lens block 108 protrudes below the lower side 110 of the chip package 102′ in FIG. 1A. In other examples, different depths of the recess in the chip package 102′ can cause the lower side of the lens block 108 to be flush with the lower side 110 of the chip package 102, or to be recessed from the lower side 110 of the chip package 102′.

In examples according to FIG. 1A, the dimension of surfaces 116′ of a receptacle 118′ in a chip-side connector 114′ will be reduced. The ferrule carrier 134 may also travel farther upward to blind-mate with the lens block 108 recessed within the chip package 102.

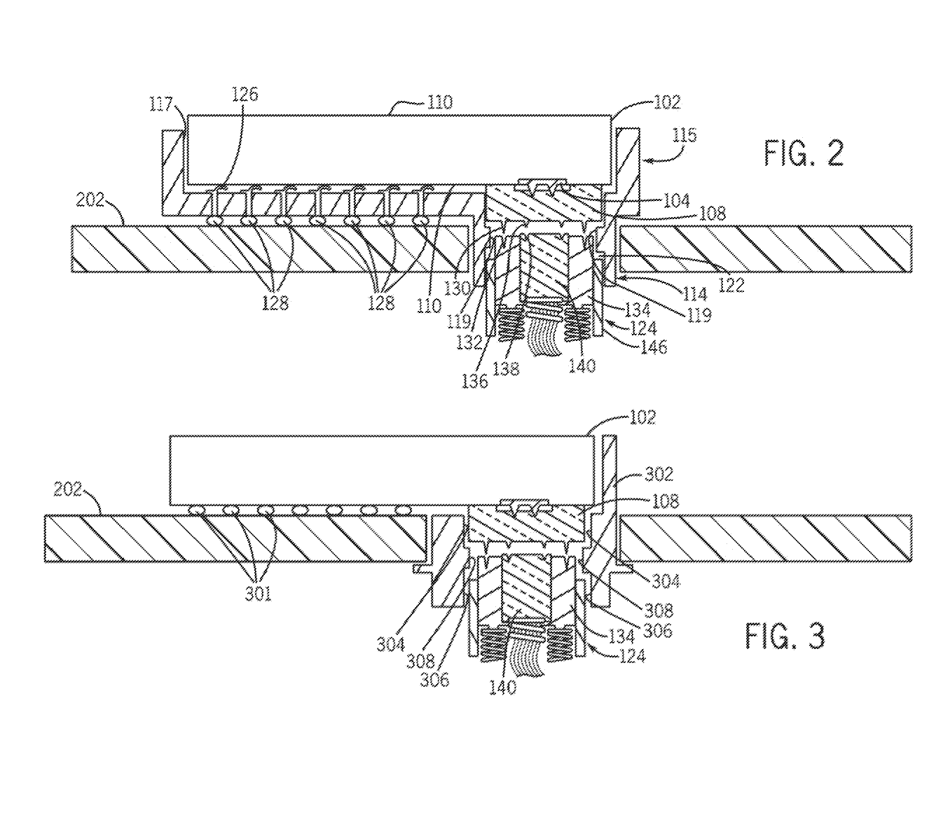

FIG. 2 illustrates the blind-made optical connection arrangement of FIG. 1 in which the chip package 102 is shown received in the receptacle 117 of the socket 115. Electrodes on the lower side 110 of the chip package 102 are electrically contacted to the electrical contacts 126 of the socket 115.

In addition, the electrical contacts 128 on the lower surface of the socket 115 are electrically contacted to respective electrodes or other electrical structures on a circuit board 202. The circuit board 202 can include electrical components, such as processors, storage devices, and/or other types of devices. The circuit board 202 can be a main circuit board or other type of coplanar board.

The lens block 108 in FIG. 2 is brought into contact with a first side of the stop feature 119. On the other side of the stop feature 119, the system-side connector 124 has not yet been fully received in the receptacle 122, and thus the housing 146 of the system-side connector 124 is not yet engaged with the stop feature 119.

As the lens block 108 and system-side optical connector 124 are brought into engagement with the chip-side connector 114, the coarse alignment features provided by the surfaces 116 and 120 (FIG. 1) of the Chip-side connector 114 provide coarse alignment of the lens block 108 with respect to the system-side optical connector 124.

As both the lens block 108 and the system-side connector 124 are brought into full engagement inside the chip-side connector 114, the alignment features 130 on the lens block 108 will first engage with respective alignment features 132 on the ferrule carrier (second level of alignment). After the second level of alignment, the alignment features 136 on the lens block 108 will next engage with respective alignment features 138 on the ferrule body 140 (third level alignment).

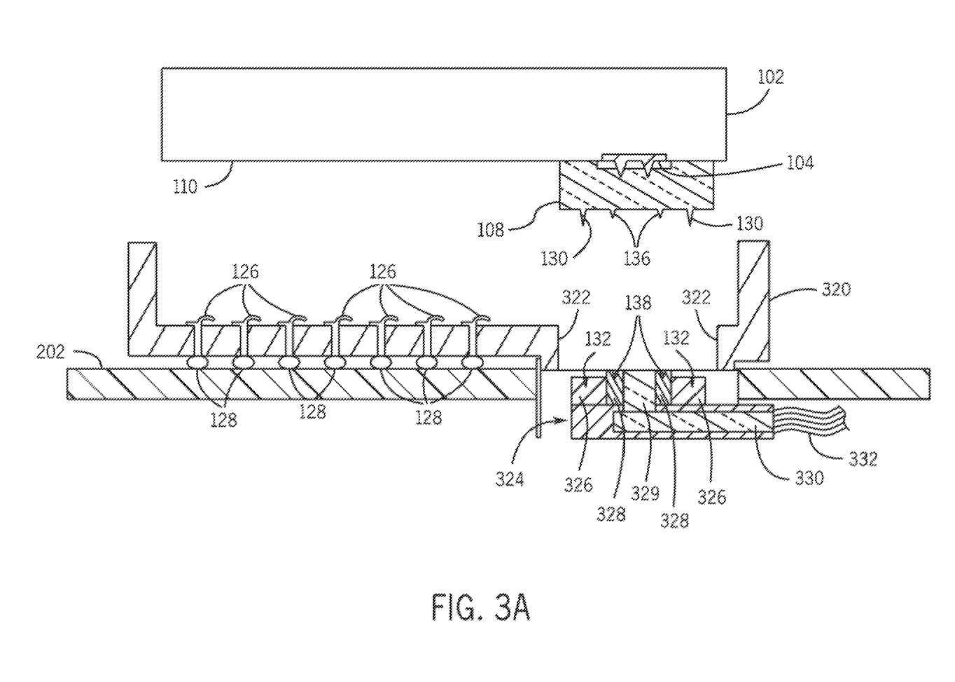

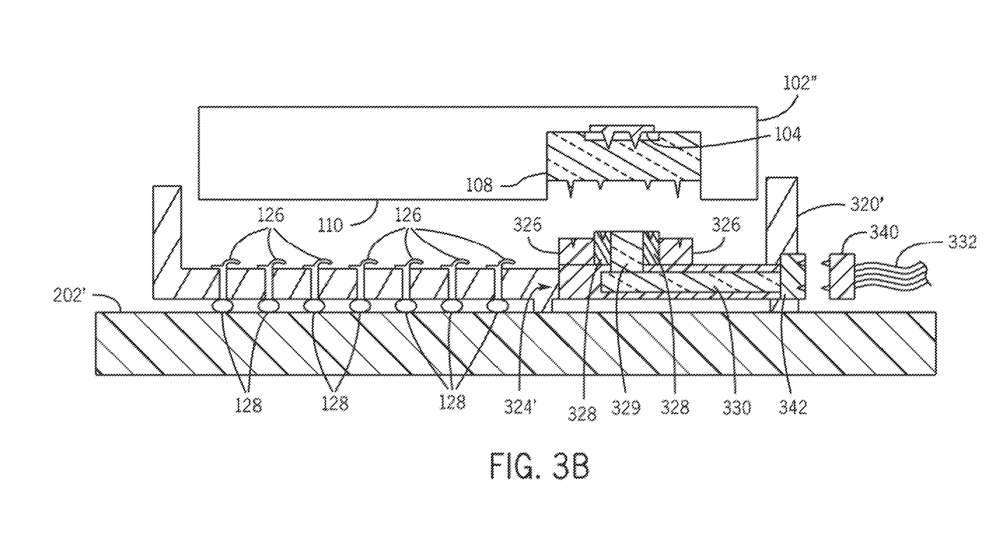

FIG. 3 depicts another example arrangement, in which the socket 115 of FIG. 2 is omitted. In FIG. 3, the chip package 102 can be directly mounted to the circuit board 202, in which case electrical contacts 301 are used to electrically connect the chip package 102 to the circuit board 202.

Instead of the socket 115, the FIG. 3 arrangement includes a mounting bracket 302, which can be extended through the circuit board 202. The mounting bracket 304 has receptacle surfaces 304 (which may be chamfered surfaces) for receiving the lens block 108, and receptacle surfaces 306 (which may be chamfered surfaces) to receive the system-side connector 124. The chamfered surfaces 304 and 306 can provide coarse mechanical alignment between the lens block 108 and the system-side connector 124.

The remaining alignment features on the lens block 108, ferrule carrier 134, and ferrule body 140 are similar to the alignment features discussed in connection with FIGS. 1 and 2.

FIG. 3A depicts a different example arrangement, which provides a lower profile system-side optical connector 324. The arrangement of the chip package 102, E/O converter 104, and lens block 108 is similar to that depicted in FIG. 1. FIG. 3A depicts a socket 320 for receiving the chip package 102. The socket 320 has side surfaces 322 defining a receptacle for receiving the lens block 108. The portion of the socket 320 for receiving the lens block 108 can be considered a chip-side connector. In some examples, the surfaces 322 can be chamfered (or slanted) surfaces to provide coarse mechanical alignment between the lens block 108 and the chip-side connector of the socket 320.

The lower profile system-side connector 324 is provided partially in an opening of the circuit board 202. A portion of the lower profile system-side connector 324 extends below the lower side of the circuit board 202. The lower profile system-side connector 324 has ferrule carriers 326 and 328 with respective alignment structures 132 and 138 for providing different levels of alignment with respective alignment structures 130 and 136 of the lens block 108, similar to the alignments discussed above. Although the ferrule carriers 326 and 328 are depicted as being separate pieces, note that they can be a single piece in other examples. A ferrule body 329 containing ferrules is held by the ferrule carrier 328. The ferrule body 329 is optically coupled to an optical waveguide 330, which is optically connected to optical fibers 332 that extend from the side the system-side optical connector 324 to allow the system-side optical connector 324 to have a lower profile.

FIG. 3B depicts another example arrangement that employs a lower profile system-side optical connector 324′. Unlike the FIG. 3A arrangement, the system-side optical connector 324′ of FIG. 38 is provided above the upper surface of a circuit board 202′. The lower profile system-side connector 324′ is provided in an opening of a socket 320′ that is to receive a chip package 102″. Similar to the arrangement depicted in FIG. 1A, the chip package 102″ has a recess into which the lens block 108 is provided. In FIG. 38, the recess is of a depth such that the lens block 108 is completely contained in the recess. A lower side of the lens block 108 is recessed from the lower side 110 of the chip package 102″.

The lower profile system-side connector 324′ is similar in construction as the lower profile system-side connector 324 of FIG. 3A, except that the waveguide 330 is connected to an optical connector 342 for mating with an optical connector 340 attached to the optical fibers 332. Again, in the example of FIG. 3B, the optical fibers 332 extend from the side of the lower profile system-side connector 324′.

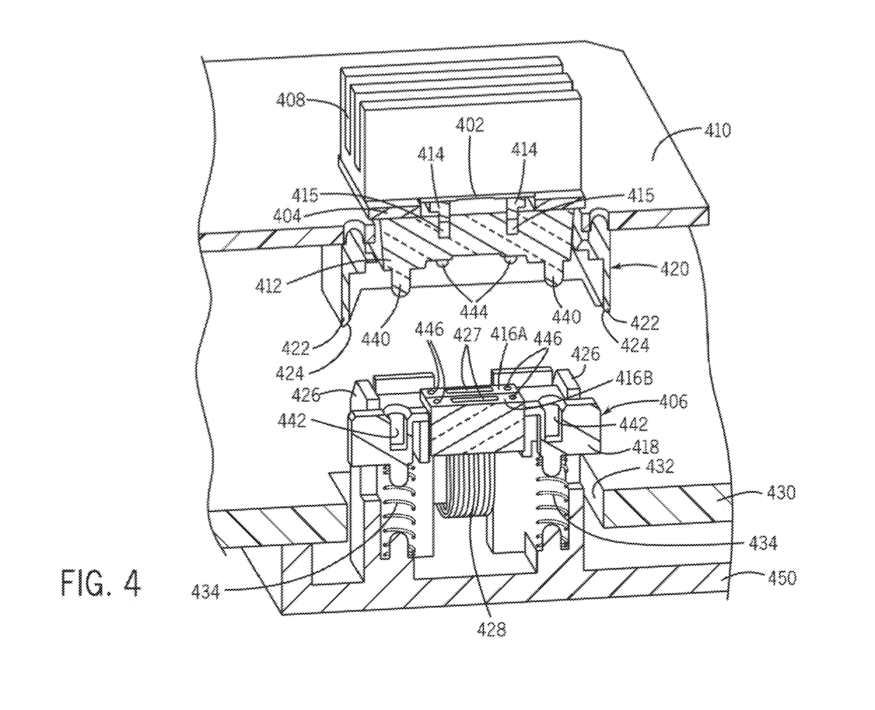

FIG. 4 illustrates another example arrangement that provides a blind-made optical connection according to some implementations. In FIG. 4, an E/O converter 402 that is attached to a chip substrate 404 can be optically mated to a system-side optical connector 406 (associated with a main circuit board 430). The chip substrate 404 and the E/O converter 402 are part of a chip package that also includes a heat sink 408. The chip package that includes the E/O converter 402, chip substrate 404, and heat sink 408 are mounted on a circuit board 410. The circuit board 410 can be a mezzanine board, which is a circuit board provided in a different plane than the main circuit board 430. Alternatively, the circuit board 410 can be an adapter card or a hot-plug card.

Note that the circuit board 410 can be located in a plane that is above or below the plane of the main circuit board 430. Alternatively, the circuit board 410 can be co-planar with the main circuit board 430, or as yet another alternative, the circuit board 410 can be orthogonally arranged with respect to the main circuit board 430.

As further depicted in FIG. 4, a lens block 412 is attached to the chip substrate 404 of the chip package. In FIG. 4, the attachment feature of the lens block 412 can be a planar surface that can be bonded to or otherwise affixed to the chip substrate 404. In addition, lens block alignment features 414, 415 are provided to align the chip substrate 404 with the lens block 412. This allows laser light to be communicated from the E/O converter 402 through the lens block 412 to ferrules that are provided on ferrule bodies 416A and 4168. The ferrule bodies 416A and 416B are carried by a ferrule carrier 418. In another example one ferrule body may be used for multiple rows of lenses instead of multiple ferrule bodies such as 416A and 4168.

A chip-side connector 420 is attached to the circuit board 410. The lens block 412 is contained inside the chip-side connector 420.

The chip-side connector 420 has engagement portions 422, which provide respective chamfered surfaces 424. The chamfered surfaces 424 are designed to provide coarse alignment with respect to respective chamfered surfaces 426 of the system-side optical connector 406.

The ferrule carrier 418 is part of the system-side optical connector 406. As noted above, the ferrule carrier 418 carries the ferrule bodies 416A and 4168. Each ferrule body 416A or 4168 includes an array of lenses 427. In another example (not shown), a ferrule with multiple arrays of lenses may be used in place of multiple ferrules such as 416A and 4168. Optical fibers 428 extend from the ferrule bodies 416A and 4168 to carry optical signals to other locations, such as other locations on the main circuit board 430. In another example, other optical waveguides may be used in place of the optical fibers 428. Also, the optical fibers 428 are shown to vertically exit the ferrule bodies with respect to the main circuit board 430. In another example (not shown), the optical fibers 430 may horizontally exit the ferrule bodies to achieve lower profile installation.

The system-side connector 406 extends through an opening 432 of the main board 430. Springs 434 bias the ferrule carrier 418 upwardly, such that the ferrule body 416 is pushed towards the lens block 412. The springs 434 are provided between the ferrule carrier 418 and an underlying support infrastructure 450. With the arrangement of FIG. 4, the system-side optical connector 406 is floated with respect to the main circuit board 430.

The lens block 412 has ferrule carrier alignment features 440, which are configured to engage respective alignment features 442 of the ferrule carrier 418. These alignment features 440 and 442 provide a second level of alignment. Additionally, alignment features 444 are provided on the lens block 412, which are to engage alignment features 446 of the ferrule bodies 416A and 4168, to provide a third level of alignment. It should be noted that the number of levels of optical alignment will depend on the specific implementation. For example, in the case of optical communication by means of focusing optics (non-collimated) between single-mode optical fibers with a relatively small core diameter (e.g. 9 um), at least two, and perhaps three levels of alignment may be employed. In the case of optical communication between larger core diameter multi-mode optical fibers with core diameter of 50 um to 800 um and employing collimating optics, a single level of alignment is likely to be adequate.

As with the arrangement depicted in FIGS. 1-3, multiple levels of alignment are provided with the arrangement of FIG. 4, including the chamfered surfaces 424, 426, alignment features 440, 442, and alignment features 444, 446.

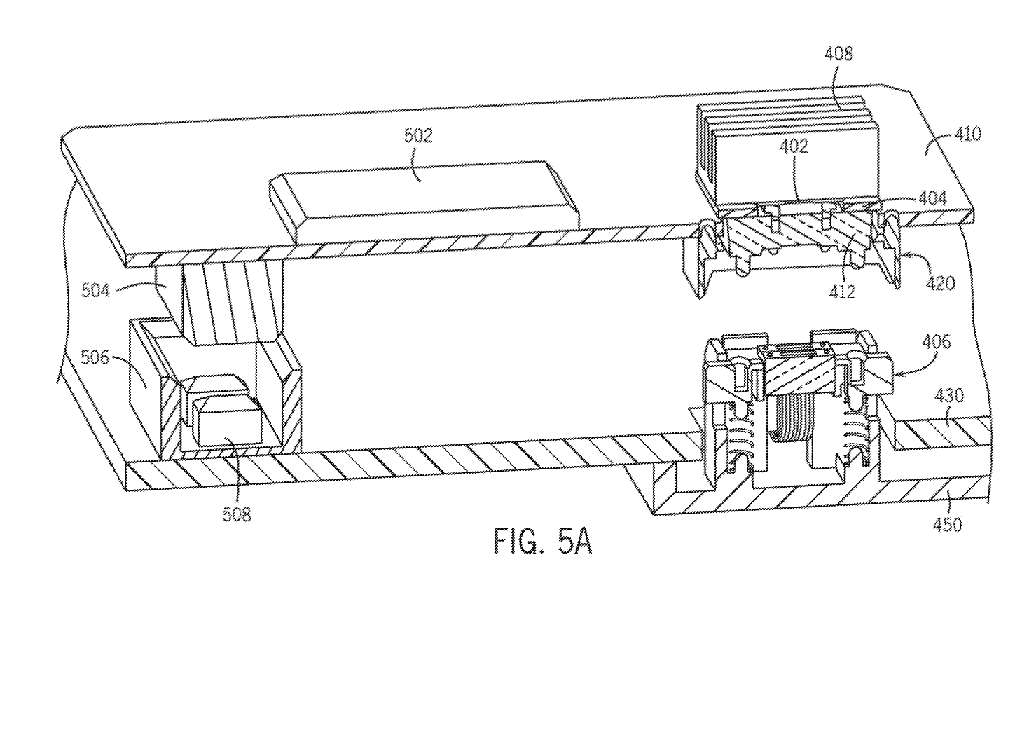

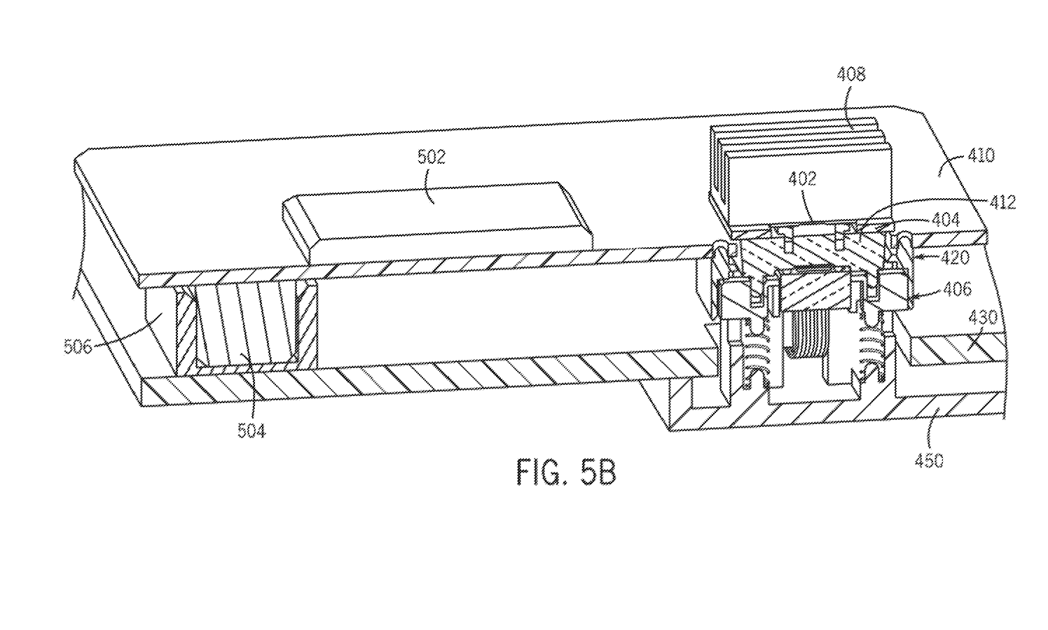

FIGS. 5A and 58 depict the arrangement of FIG. 4 in a larger view. The circuit board 410 of FIG. 5A or 58 includes another electronic component 502, in addition to the chip package that includes the chip substrate 404, E/O converter 402, and heat sink 408. There may be other electronic components on the circuit board 410 that are not shown.

In addition to the blind-mate optical connection arrangement that includes the chip-side connector 420 and system-side optical connector 406, FIGS. 5A and 58 further depict an electrical connection mechanism. The electrical connection mechanism includes an electrical connector 504 that is attached to the circuit board 410, and another electrical connector 506 that is attached the main circuit board 430. The main circuit board electrical connector 506 has pins 508 for electrical connection to respective features of the electrical connector 504.

In accordance with some implementations, simultaneous electrical and optical connection can be achieved using the arrangement depicted in FIG. 5A. FIG. 5A shows an arrangement prior to engagement of the optical and electrical connectors, while FIG. 58 shows the arrangement after engagement of the optical and electrical connectors.

The optical connection mechanism of FIGS. 4, 5A, and 5B (including the chip-side connector 420, lens block 412, and system-side optical connector 406) can be over-driven, such that enhanced tolerance is provided along the mating axis of the optical connection mechanism. This allows the electrical connection mechanism to fully engage (to allow the electrical contacts to fully wipe), before the optical connection is fully engaged.

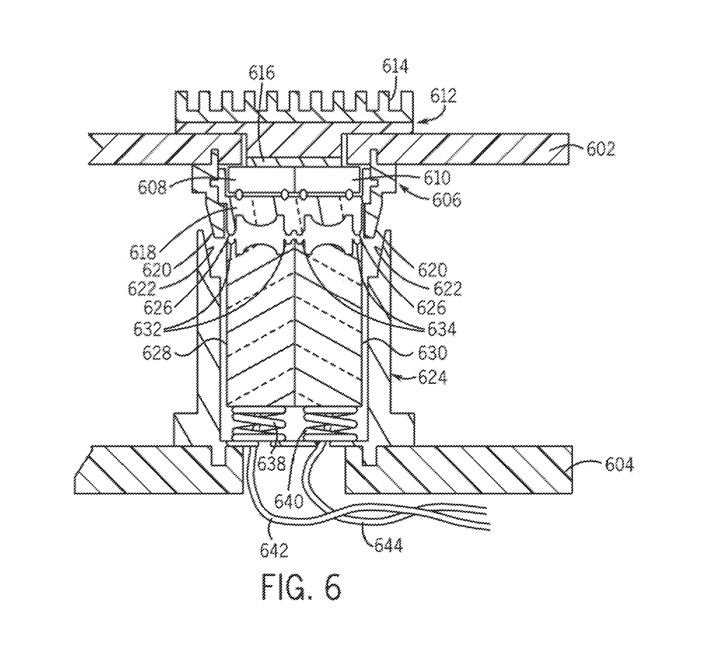

FIG. 6 is a side view of an arrangement according to further alternative implementations. In FIG. 6, a mezzanine circuit board 602 and a main circuit board 604 are provided generally in parallel to each other. A mezzanine-side connector 606 is attached to the mezzanine circuit board 602. In examples according to FIG. 6, two E/O converters 608 and 610 are shown, where the E/O converter 608 and 610 can be mounted on the mezzanine circuit board 602. In some examples, a heat sink 612 having heat fins 614 can be provided and is thermally coupled to the E/O converters 608, 610, through a thermally conductive layer 616. The heat sink 612 extends through an opening of the mezzanine circuit board 602 to thermally contact the thermally conductive layer 616.

A lens block 618 is placed adjacent the E/O converters 608 and 610. The lens block 618 has lenses through which laser light communicated with the E/O converters 608 and 610 passes.

The mezzanine-side connector 606 has chamfered surfaces 620, which are configured to engage corresponding chamfered surfaces 622 on a system-side optical connector 624. The chamfered surfaces 620 and 622 of the respective connectors 606 and 624 provide coarse mechanical alignment of the optical connection mechanism depicted in FIG. 6.

The lens block 618 further includes alignment features 626, which are used to provide fine alignment between the lens block 618 and ferrule bodies 628 and 630 that are part of the system-side optical connector 624. Each ferrule body 628 or 630 contains a number of ferrules that are to communicate light through the lens block 618 with the E/O converters 608 and 610, respectively. The ferrule body 628 has fine alignment features 632 to engage corresponding ones of the fine alignment features 626 of the lens block 618. Similarly, the ferrule body 630 has fine alignment features 634 that are to engage the corresponding fine alignment features 626 of the lens block 618.

Springs 638 and 640 are provided at the bottom of ferrule bodies 628 and 630, to bias the ferrule bodies against the lens block 618 when the connectors 606 and 624 are engaged. In addition, optical fibers 642 and 644 extend from respective ones of the ferrule bodies 628 and 630 to provide optical connections to other locations.

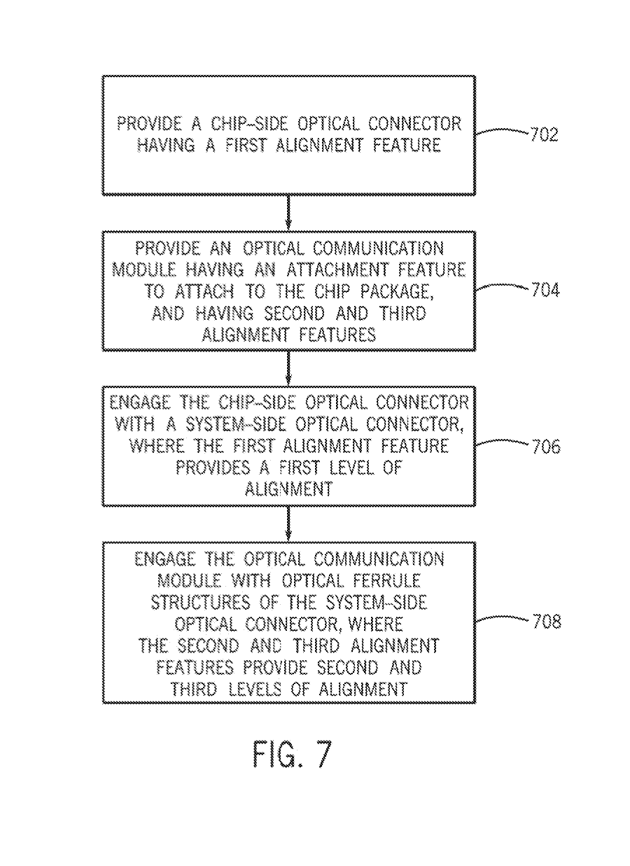

FIG. 7 is a flow diagram of assembling an assembly according to some implementations. The process provides (at 702) a chip-side optical connector (e.g. 114 in FIG. 1, 420 in FIG. 4, 606 in FIG. 6) having a first alignment feature.

The process further provides (at 704) an optical communication module (e.g. the lens block 108 in FIG. 1, lens block 412 in FIG. 4, or lens block 618 in FIG. 6) that has an attachment feature to attach to a chip package. The optical communication module has second and third alignment features.

The process engages (at 706) the chip-side optical connector with a system-side optical connector (e.g. 124 in FIG. 1, 406 in FIG. 4, or 624 in FIG. 6), where the first alignment feature provides a first (coarse) level of alignment.

The process next engages (at 708) the optical communication module with optical ferrule structures (e.g. 134, 140 in FIG. 1, 416A, 4168, 418 in FIG. 4, or 628, 630 in FIG. 6) of the system-side optical connector, where the second and third alignment features provide second and third levels of alignment.

By using blind-mate optical connection arrangements according to some implementations, system manufacturing and assembly can be simplified enabling lower system costs. In addition, users can install or service chip packages in a system without having to manipulate dense arrangements of optical fibers. Also, optical fiber connectivity between circuit boards and system-side optical connectors can be hidden and protected from the users, which can lead to easier-to-use and more reliable systems. Additionally, optical fibers in the system can be more easily organized.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. An apparatus for optically connecting a chip package to a system-side optical connector, comprising:
a chip-side optical connector for engaging the chip package and having a first alignment feature positioned to engage a corresponding feature of the system-side optical connector to achieve a first level of alignment with the system-side optical connector; and
an optical communication module having an attachment feature configured for attachment to the chip package having an electrical-optical converter, the optical communication module to pass light communicated with an electrical-optical converter of the chip package,
wherein the optical communication module has a second alignment feature positioned to engage a corresponding feature of an optical ferrule structure in the system-side optical connector to achieve a second level of alignment with the system-side optical connector.

2. The apparatus of claim 1, wherein the optical ferrule structure is a carrier to carry an optical ferrule body having at least one optical ferrule to communicate optically with the electrical-optical converter through the optical communication module, and
wherein the optical communication module has another alignment feature positioned to engage a corresponding feature of the optical ferrule body to achieve another level of alignment with the system-side optical connector.

3. The apparatus of claim 1, wherein the optical communication module includes a lens block having at least one lens through which the light communicated with the electrical-optical converter is passed.

4. The apparatus of claim 1, further comprising electrical contacts mounted to the chip package, wherein the electrical contacts mate with corresponding electrical contacts of a circuit board concurrently with mating of the chip-side optical connector with the system-side optical connector.

5. The apparatus of claim 1, wherein the chip package is a circuit board or an integrated circuit device.

6. A system comprising:
a chip package having an electrical-optical converter;
a system-side optical connector; and
an optical communication module having an attachment feature configured for attachment to the chip package, the optical communication module to pass light communicated with the electrical-optical converter,
where the optical communication module comprises:
a first alignment feature positioned to engage a corresponding feature of the system-side optical connector to achieve a first level of alignment between the optical communication module and the system-side optical connector, and
a second alignment feature positioned to engage a corresponding feature of an optical ferrule body of the system-side optical connector to achieve a second level of alignment between the optical communication module and the system-side optical connector.

7. The system of claim 6, further comprising a chip-side optical connector having an alignment feature to engage an alignment feature of the system-side optical connector, to provide a coarse level of alignment, different from the first and second levels of alignment, with the system-side optical connector.

8. The system of claim 7, further comprising a circuit board, wherein the chip-side optical connector is part of a socket that is mounted to the circuit board.

9. The system of claim 8, wherein the socket has electrical contacts to contact electrodes on the circuit board, and wherein the socket has a receptacle to receive at least a portion of the chip package.

10. The system of claim 7, further comprising a circuit board, and a mounting structure attached to the circuit board, wherein the chip-side optical connector is part of the mounting structure, and wherein the chip package is directly mounted to the circuit board.

11. The system of claim 6, wherein the optical communication module is provided in a recess of the chip package.

12. The system of claim 6, further comprising a main circuit board associated with the system-side optical connector, wherein the chip package is a circuit board in a plane separate from a plane of the main circuit board.

13. The system of claim 6, further comprising optical fibers that extend from a side of the system-side optical connector to reduce a profile of the system-side optical connector.

14. The system of claim 6, wherein the chip-side optical connector and system-side optical connector are arranged to have an over-driven tolerance to allow electrical connectors to completely mate prior to full mating of the optical connectors.

15. A method comprising:
providing an optical communication module that has an attachment feature to attach to a chip package, the chip package having an electrical-optical converter, where the optical communication module is to pass light communicated with the electrical-optical converter, and where the optical communication module has first and second alignment features; and
engaging the optical communication module with a system-side optical connector having an optical ferrule, where the first alignment feature provides a first level of alignment, and where the second alignment feature provides a second level of alignment.
